(19) United States
(12) Patent Application Publication
(10) Pub. No.: US 2016/0313215 A1
(43) Pub. Date: Oct. 27, 2016

(54) APPARATUS FOR DETERMINING CONCENTRIC MOUNTING OF A TIRE ON A WHEEL

(71) Applicant: Bridgestone Americas Tire Operations, LLC, Nashville, TN (US)

(72) Inventors: Todd Alan Buxton, Norton, OH (US); Jason R. Misutka, New Franklin, OH (US); Steven Mark Sawyer, Akron, OH (US); Christopher A. Swartzwelder, Akron, OH (US); Guy Joseph Walenga, Mount Juliet, TN (US); Reubin R. Close, Diamond, OH (US)

(21) Appl. No.: 15/132,793

(22) Filed: Apr. 19, 2016

Related U.S. Application Data
(60) Provisional application No. 62/150,334, filed on Apr. 21, 2015.

(51) Int. Cl. G01M 17/02

(52) U.S. Cl. CPC G01M 17/02

(57) ABSTRACT

An apparatus for determining concentric mounting of a tire on a wheel is provided. In one embodiment, an apparatus for determining concentric mounting of a tire on a wheel is provided, the apparatus comprising: a head portion including a viewfinder; a body portion including at least one index member; and a neck portion connecting the head portion to the body portion.

### CROSS-REFERENCE TO RELATED APPLICATIONS

This application claims priority from U.S. Provisional Patent Application No. 62/150,334, filed on Apr. 21, 2015, which is incorporated by reference herein in its entirety.

### BACKGROUND

When mounting a tire upon a rim, it is important to ensure that the tire and rim are at least substantially concentric. That is, an accepted industry tolerance exists for a tire's placement on a rim. An eccentric tire and rim relationship, outside of the accepted industry tolerance, may lead to irregular wear and reduced tread life.

Some tires include substantially circumferential lines extending about the sidewall of the tire. These lines are referred to as a first rim line and a second rim line. The first rim line, if available, is typically used by tire manufacturers and engineers as a reference point for analyzing tire sections. The first rim line is sometimes concealed from view by the rim's flange when the tire is mounted on the rim. However, the first rim line, which is ordinarily positioned at least somewhat radially-outwardly from the rim's flange, may also be utilized as a point against which to measure offset between a rim and a tire, and thus identify whether the tire and rim relationship is within the specified tolerances. Because the first rim line is often positioned radially-outwardly from the rim's flange in the tire's sidewall by some distance, an individual is required to take multiple measurements between the first rim line and the rim, about various points on the circumference of the rim. Due the curvature of the rim, it is difficult to obtain an accurate measurement between the first rim line and the rim.

What is needed is an apparatus for ensuring that a tire and rim are concentric using a tire having rim centering tolerance indicators that create multiple visual points of reference.

### SUMMARY

In one embodiment, an apparatus for determining concentric mounting of a tire on a wheel is provided, the apparatus comprising: a head portion including a viewfinder; a body portion including at least one index member; and a neck portion connecting the head portion to the body portion.

In one embodiment, a system for determining concentric mounting of a tire on a wheel is provided, the system comprising: an apparatus for determining concentric mounting of a tire on a wheel, comprising: a head portion including a viewfinder; a body portion including at least one index member; and a neck portion connecting the head portion to the body portion a wheel comprising a rim flange; and a tire mounted on the wheel, the tire including a sidewall comprising at least one rim centering tolerance indicator.

### BRIEF DESCRIPTION OF THE DRAWINGS

The accompanying figures, which are incorporated in and constitute a part of the specification, illustrate various example systems and apparatuses, and are used merely to illustrate various example embodiments. In the figures, like elements bear like reference numerals.

FIG. 1A illustrates a side elevation view of an example embodiment of an apparatus 100 for determining concentric mounting of a tire on a wheel.

FIG. 1B illustrates a front elevation view of an example embodiment of apparatus 100 for determining concentric mounting of a tire on a wheel.

FIG. 1C illustrates a rear elevation view of an example embodiment of apparatus 100 for determining concentric mounting of a tire on a wheel.

FIG. 1D illustrates an example embodiment of apparatus 100 operatively connected to a wheel 120.

FIG. 2A illustrates a side elevation view of an example embodiment of an apparatus 200 for determining concentric mounting of a tire on a wheel.

FIG. 2B illustrates a front elevation view of an example embodiment of apparatus 200 for determining concentric mounting of a tire on a wheel.

FIG. 2C illustrates a rear elevation view of an example embodiment of apparatus 200 for determining concentric mounting of a tire on a wheel.

FIG. 2D illustrates an example embodiment of apparatus 200 operatively connected to a wheel 220.

FIG. 2E illustrates an example embodiment of apparatus 200 operatively connected to wheel 220.

FIG. 3A illustrates a partial view of an example embodiment of an apparatus 300 operatively connected to a wheel 320 and aligned with one or more rim centering tolerance indicators 332A, 332B, and 332C.

FIG. 3B illustrates a partial view of an example embodiment of apparatus 300 operatively connected to wheel 320 and aligned relative to rim centering tolerance indicators 332A, 332B, and 332C.

FIG. 4 illustrates a rear elevation view of an example embodiment of an apparatus 400 for determining concentric mounting of a tire on a wheel.

FIG. 5 illustrates a rear elevation view of an example embodiment of an apparatus 500 for determining concentric mounting of a tire on a wheel.

FIG. 6A illustrates a rear perspective view of an example embodiment of an apparatus 600 for determining concentric mounting of a tire on a wheel.

FIG. 6B illustrates a front perspective view of an example embodiment of apparatus 600 for determining concentric mounting of a tire on a wheel.

FIG. 7A illustrates a rear perspective view of an example embodiment of an apparatus 700 for determining concentric mounting of a tire on a wheel.

FIG. 7B illustrates a front perspective view of an example embodiment of apparatus 700 for determining concentric mounting of a tire on a wheel.

### DETAILED DESCRIPTION

When a tire is mounted on a rim, the fitment between the tire and the rim may be such that the tire may actually mount on the rim without being within the industry accepted rim centering tolerance. That is, an industry standard tolerance for tire and rim alignment, herein referred to as a rim centering tolerance, exists to ensure that a tire is centered on a rim within an acceptable degree of error to avoid the negative effects of tire and rim eccentricity. It is understood that a tire that is perfectly centered on a rim is concentric with the rim, such that the tire and the rim share the same radial center point.

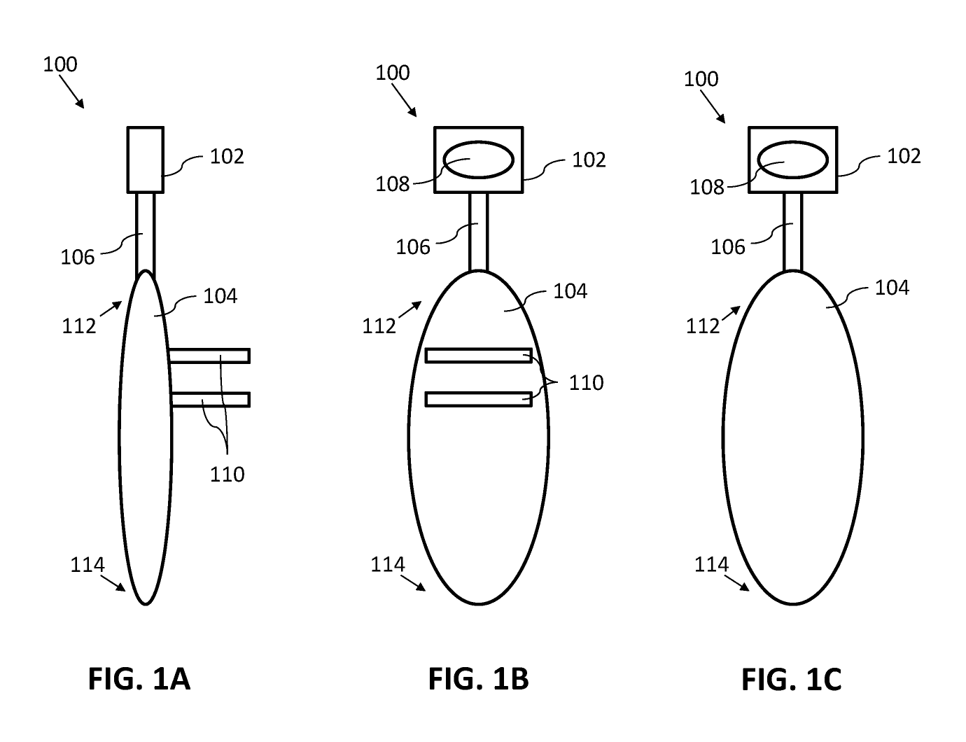

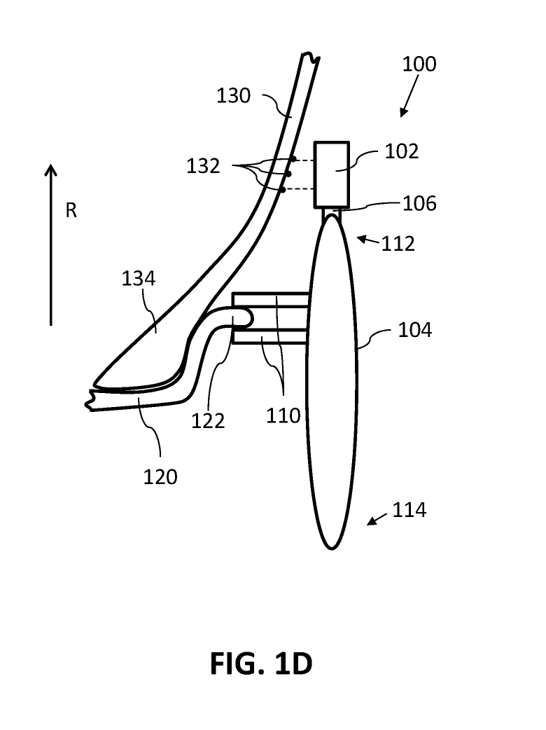

FIG. 1A illustrates an apparatus 100 for determining concentric mounting of a tire on a wheel. Apparatus 100 may include a head portion 102, a body portion 104, and a neck portion 106 connecting head portion 102 to body portion 104. Apparatus 100 may include at least one index member 110. Body portion 104 may include a distal end 112 and a proximal end 114.

Apparatus 100 may include any of a variety of materials, including for example: a polymer, a metal, an alloy, a composite, an organic material, a ceramic, a glass, and the like.

Head portion 102 may include a substantially cuboid-shaped element. Head portion 102 may include any shape of element. Head portion 102 may include an oval-shaped element.

Body portion 104 may include any of a variety of shapes, including for example a cylinder, an ellipsoid, a cuboid, and the like. Body portion 104 may be configured at least partially to be grasped by a user's hand. At least a portion of body portion 104 may be configured to be used as a handle. Body portion 104 may include a magnet.

At least one index member 110 may extend from body portion 104. At least one index member 110 may extend from body portion 104 at distal end 112. At least one index member 110 may extend from body portion 104 near distal end 112. At least one index member 110 may extend from body portion 104 at any position on body portion 104. At least one index member 110 may include any of a variety of shapes, including for example a cuboid, a cylinder, and the like. At least one index member 110 may be configured to contact a portion of a wheel. At least one index member 110 may be configured to engage a portion of a wheel. At least one index member 110 may be configured to contact a rim flange of a wheel. At least one index member 110 may be configured to engage a rim flange of a wheel. At least one index member 110 may be configured to contact a portion of a center bore of a wheel. At least one index member 110 may be configured to engage a portion of a center bore of a wheel. At least one index member 110 may be configured to contact a lug hole of a wheel. At least one index member 110 may be configured to engage a lug hole of a wheel. At least one index member 110 may include a magnet.

At least one index member 110 may include at least two index members 110. At least one of the at least two index members 110 may be configured to move relative to one another toward at least one of distal end 112 and proximal end 114. At least two index members 110 may be configured to engage a portion of a vehicle wheel in a clamping manner, such that the two index members 110 provide a force toward one another on a portion of a vehicle wheel. In one embodiment, at least two index members 110 may be aligned in close proximity to, but not exerting force upon, a portion of a vehicle wheel. In another embodiment, either of at least two index members 110 may contact a portion of a vehicle wheel, either on two sides of the portion of the vehicle wheel, or on the same side of the vehicle wheel. In another embodiment, two index members 110 may be adjusted into contact with one another, and at least one of two index members 110 may be contacted to a portion of a vehicle wheel.

At least one of at least one index member 110 may be moveably connected to body portion 104. At least one of at least one index member 110 may be slideably connected to body portion 104, such that at least one index member 110 may selectively slide toward at least one of distal end 112 and proximal end 114. At least one of at least one index member 110 may be pivotably connected to body portion 104, such that at least one index member 110 may selectively pivot toward at least one of distal end 112 and proximal end 114. At least one of at least one index member 110 may be configured to selectively slide, pivot, or otherwise move, toward another of at least one index member 110.

At least one index member 110 may be selectively movable via rotation of a threaded shaft. At least one index member 110 may be selectively movable via a friction fit element. At least one index member 110 may be selectively movable via rotation and actuation of a rack and pinion system. At least one index member 110 may be selectively movable via a track permitting translation of that at least one index member 110.

Neck portion 106 may include any of a variety of shapes, including for example, cylindrical, cuboid, and the like. Neck portion 106 may be selectively adjustable in its longitudinal length. Neck portion 106 may be at least partially telescoping, including at least two independent components configured to extend into and about one another. At least a portion of neck portion 106 may be configured to selectively extend into at least a portion of body portion 104. At least a portion of neck portion 106 may be configured to selectively extend into head portion 102. Neck portion 106 may be configured to permit head portion 102 and body portion 104 to move relative to one another. Neck portion 106 may be configured to permit head portion 102 and body portion 104 to move toward one another and away from one another.

Neck portion 106 may include a threaded shaft, such that rotation of head portion 102 relative to body portion 104 causes the distance between head portion 102 and body portion 104 to increase or decrease. Body portion 104 may include a threaded cavity extending from distal end 112, corresponding to a threaded shaft of neck portion 106, and configured to accept at least a portion of neck portion 106. Head portion 102 may include a threaded cavity corresponding to a threaded shaft of neck portion 106 and configured to accept at least a portion of neck portion 106.

Neck portion 106 may include a shaft having transverse grooves and a detent element, such that a user may translate head portion 102 longitudinally relative to body portion 104 to cause the distance between head portion 102 and body portion 104 to increase or decrease. Body portion 104 may include a cavity extending from distal end 112 and configured to accept at least a portion of neck portion 106. Head portion 102 may include a cavity configured to accept at least a portion of neck portion 106.

Neck portion 106 may include a shaft friction fit into a cavity extending into body portion 104 from distal end 112, such that neck portion 106 may be forced to translate longitudinally into the cavity.

FIGS. 1B and 1C illustrate apparatus 100 for determining concentric mounting of a tire on a wheel. Head portion 102 may include a viewfinder 108.

Viewfinder 108 may include an aperture extending completely through head portion 102. Viewfinder 108 may be configured to allow a user to look through head portion 102. Viewfinder 108 may include a lens. Viewfinder 108 may include a lens including at least one reference mark or reference line. Viewfinder 108 may include an elliptical or oval shape. Viewfinder 108 may include any of a variety of shapes, including circular, rectangular, square, and the like.

Viewfinder 108 may include a height corresponding to a radial distance between two rim centering tolerance indicators (not shown). Viewfinder 108 may include a height corresponding to a radial distance between the first and the third in a series of three rim centering tolerance indicators.

FIG. 1D illustrates apparatus 100 operatively connected to a wheel 120. Wheel 120 may include a rim flange 122. A tire having a sidewall 130 may be mounted upon wheel 120 to create a tire and wheel assembly. Tire sidewall 130 may include at least one rim centering tolerance indicator 132. The tire may include a bead portion 134 engaging wheel 120.

In one embodiment, at least one index member 110 may include two index members 110. The two index members 110 may be oriented on two sides of rim flange 122. The two index members 110 may clamp onto rim flange 122. The two index members 110 may be oriented adjacent to rim flange 122 without imparting force onto rim flange 122. A user may orient the two index members 110 as desired relative to rim flange 122.

A user may adjust neck portion 106 to orient head portion 102 relative to at least one rim centering tolerance indicator 132. Head portion 102 may be oriented such that at least one rim centering tolerance indicator 132 is visible through viewfinder 108. In one embodiment, at least one rim centering tolerance indicator 132 includes three rim centering tolerance indicators, and viewfinder 108 is oriented such that it is centered on the radially middle rim centering tolerance indicator. Viewfinder 108 may include a lens having at least one reference mark, and at least one reference mark may be aligned with the radially middle rim centering tolerance indicator of three rim centering tolerance indicators.

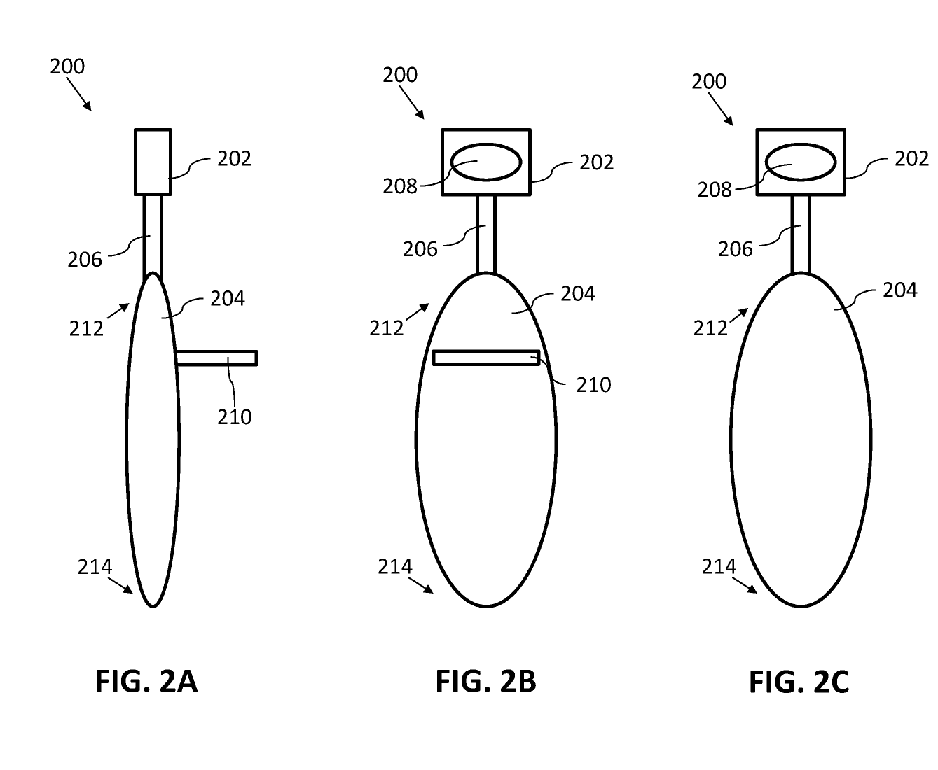

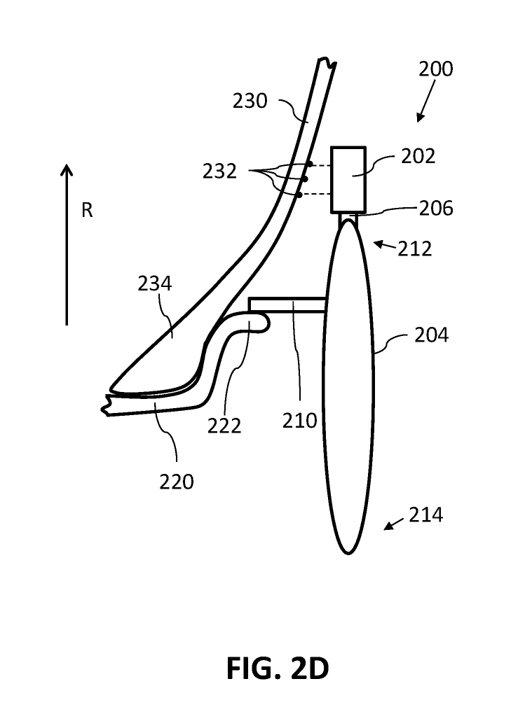

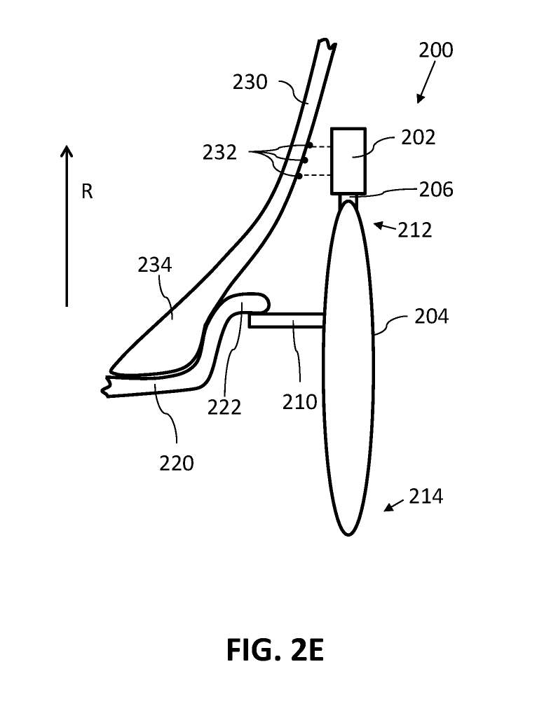

FIG. 2A illustrates an apparatus 200 for determining concentric mounting of a tire on a wheel. Apparatus 200 may include a head portion 202, a body portion 204, and a neck portion 206 connecting head portion 202 to body portion 204. Apparatus 200 may include an index member 210. Body portion 204 may include a distal end 212 and a proximal end 214.

FIGS. 2B and 2C illustrate apparatus 200 for determining concentric mounting of a tire on a wheel. Head portion 202 may include a viewfinder 208.

FIGS. 2D and 2E illustrate apparatus 200 operatively connected to a wheel 220. Wheel 220 may include a rim flange 222. A tire having a sidewall 230 may be mounted upon wheel 220 to create a tire and wheel assembly. Tire sidewall 230 may include at least one rim centering tolerance indicator 232. The tire may include a bead portion 234 engaging wheel 220.

In one embodiment, index member 210 may include a single index member 210. Index member 210 may be oriented on a single side of rim flange 222. A user may orient index member 210 as desired relative to rim flange 222. For example, a user may orient index member 210 in contact with a radially outward edge of rim flange 222 or a radially inward edge of rim flange 222.

A user may adjust neck portion 206 to orient head portion 202 relative to at least one rim centering tolerance indicator 232. Head portion 202 may be oriented such that at least one rim centering tolerance indicator 232 is visible through viewfinder 208. In one embodiment, at least one rim centering tolerance indicator 232 includes three rim centering tolerance indicators, and viewfinder 208 is oriented such that it is centered on the radially middle rim centering tolerance indicator. Viewfinder 208 may include a lens having at least one reference mark, and at least one reference mark may be aligned with the radially middle rim centering tolerance indicator of three rim centering tolerance indicators.

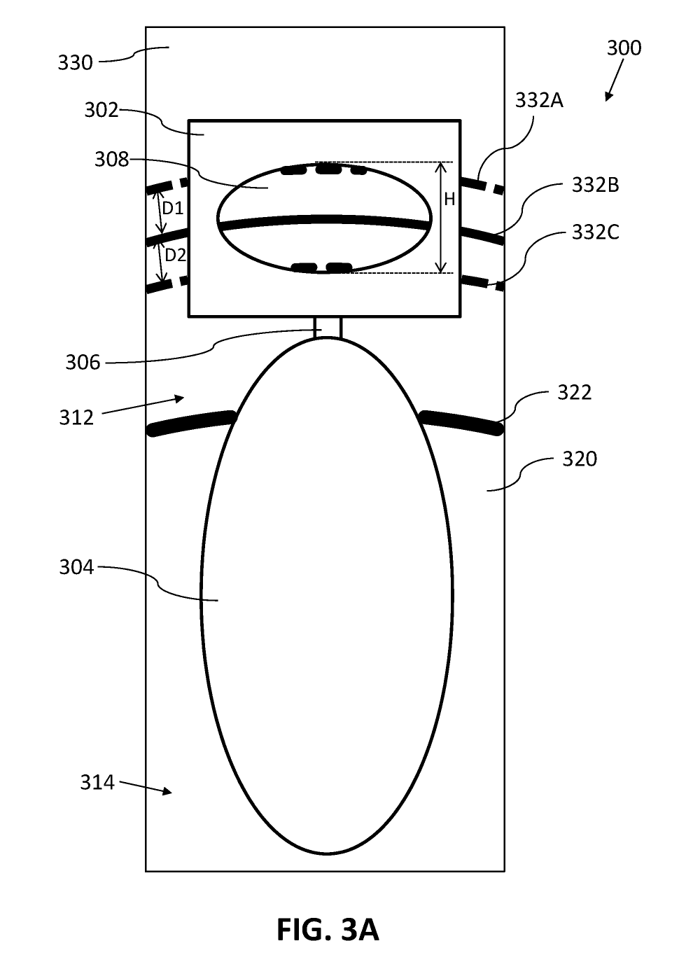

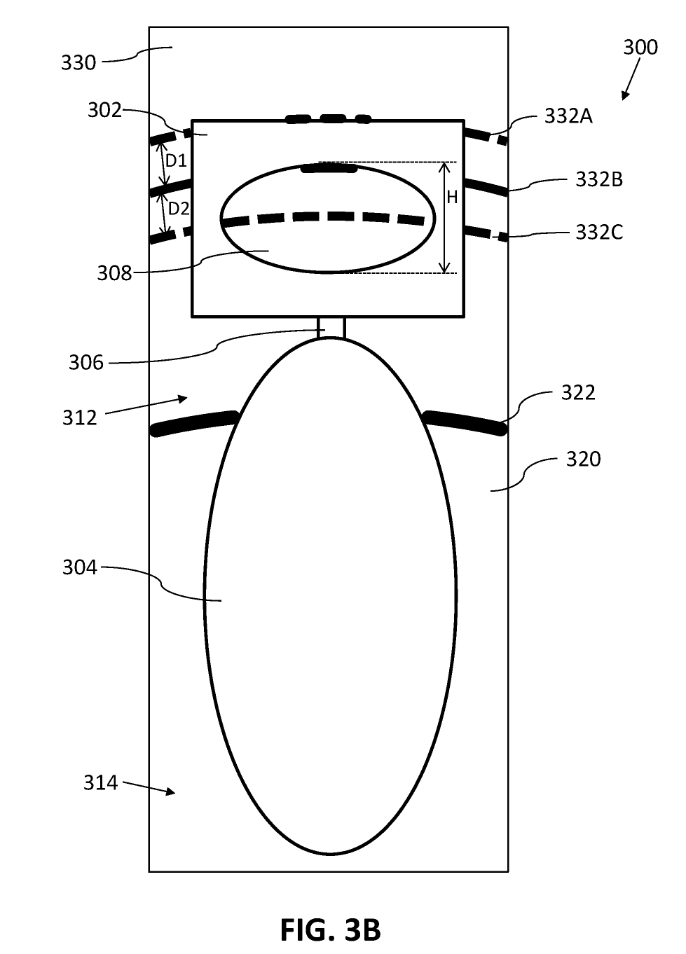

FIG. 3A illustrates an apparatus 300 operatively connected to a wheel 320 and aligned with one or more rim centering tolerance indicators 332A, 332B, and 332C.

Apparatus 300 may include a head portion 302, a body portion 304, and a neck portion 306 connecting head portion 302 to body portion 304. Head portion 302 may include a viewfinder 308. Apparatus 300 may include at least one index member 310. Body portion 304 may include a distal end 312 and a proximal end 314.

Wheel 320 may include a rim flange 322. A tire may be mounted on wheel 320 to form a tire and wheel assembly. The tire may include a sidewall 320, having at least one rim centering tolerance indicator 332A, 332B, and 332C.

Apparatus 300 may be operatively connected to wheel 320 via engagement between at least one index member (not shown) and rim flange 322. A user may adjust neck portion 306 to orient head portion 302 and viewfinder 308 relative to rim centering tolerance indicators 332A, 332B, and 332C. A radially middle rim centering tolerance indicator 332B may be centered within viewfinder 308. A user may remove apparatus 300 from a first point on wheel 320, and without adjustment of neck portion 306, replace apparatus 300 at a second point on wheel 320 circumferentially displaced from the first point. A user may repeat this process at any number of points along the circumference of wheel 320.

In one embodiment, the first point and the second point are about 180 degrees from one another. In another embodiment, the first point and the second point are about 90 degrees from one another. In another embodiment, the first point and the second point are about 120 degrees from one another. In another embodiment, a third point may be 120 degrees from the first point and the second point. In another embodiment, a fourth point may be 90 degrees from the first point and the third point, with a second point also being 90 degrees from the first point and the third point. In another embodiment, the first point and the second point are between about 90 degrees and about 180 degrees from one another.

In one embodiment, apparatus 300 is applied to wheel 320 at any of a number of points circumferentially spaced from one another, including at least two points, at least three points, at least four points, and the like.

In practice, a user may apply apparatus 300 to wheel 320 at a first point and adjust neck portion 306 so as to center viewfinder 308 upon a targeted circumferential reference point on sidewall 330, such as for example at least one of rim centering tolerance indicators 332A, 332B, and 332C. Subsequently a user may remove apparatus 300 from the first point and, without adjusting neck portion 306, apply apparatus 300 to a second point circumferentially spaced from the first point. A user may observe the alignment of the targeted circumferential reference point on sidewall 330 at the second point, such as for example at least one of rim centering tolerance indicators 332A, 332B, and 332C, so as to determine whether the targeted circumferential reference point is still within viewfinder 308. If the targeted circumferential reference point, such as at least one of rim centering tolerance indicators 332A, 332B, and 332C, is within viewfinder 308 at the second point, then the tire may be concentric with rim 320 within allowable tolerances. If the targeted circumferential reference point, such as at least one of rim centering tolerance indicators 332A, 332B, and 332C, is not within viewfinder 308 at the second point, then the tire may not be concentric with rim 320 within allowable tolerances, and the tire may need to be removed from rim 320 and remounted.

In one embodiment, the tire comprises at least one rim centering tolerance indicator 332A, 332B, and 332C. At least one rim centering tolerance indicator 332A, 332B, and 332C may be oriented in at least one bead area of tire (not shown). In one embodiment, no rim centering tolerance indicator 332A, 332B, and 332C is oriented on sidewall 330. At least one rim centering tolerance indicator 332A, 332B, and 332C may be oriented on a lower, radially inward, portion of sidewall 330. At least one rim centering tolerance indicator 332A, 332B, and 332C may include a plurality of rim centering tolerance indicators 332A, 332B, and 332C. At least one rim centering tolerance indicator 332A, 332B, and 332C may include at least two rim centering tolerance indicators 332A, 332B, and 332C. At least one rim centering tolerance indicator 332A, 332B, and 332C may include at least three rim centering tolerance indicators 332A, 332B, and 332C.

At least one rim centering tolerance indicator 332A, 332B, and 332C may comprise at least one of a substantially circumferential ring, and a discontinuous reference mark. In one embodiment, at least one rim centering tolerance indicator 332A, 332B, and 332C comprises at least one ring extending about the circumference of at least one bead area. In another embodiment, at least one rim centering tolerance indicator 332A, 332B, and 332C comprises at least one reference mark. In another embodiment, at least one rim centering tolerance indicator 332A, 332B, and 332C comprises a combination of any number of substantially circumferential rings and reference marks. In another embodiment, at least one rim centering tolerance indicator 332A, 332B, and 332C comprises a substantially solid circumferential ring. In another embodiment, at least one rim centering tolerance indicator 332A, 332B, and 332C comprises a discontinuous circumferential ring. In another embodiment, at least one rim centering tolerance indicator 332A, 332B, and 332C comprises a combination of at least one substantially solid circumferential ring and at least one discontinuous circumferential ring. In one embodiment, at least one rim centering tolerance indicator 332A, 332B, and 332C comprises a first rim line. In another embodiment, at least one rim centering tolerance indicator 332A, 332B, and 332C comprises a first rim groove. In another embodiment, at least one rim centering tolerance indicator 332A, 332B, and 332C comprises any feature of a tire that extends about a tire at a specific radial distance from the center of the tire, including for example: a rim line, a rim groove, a rim guard, a shoulder groove, indicia, design, or text on a tire sidewall, and the like.

At least one rim centering tolerance indicator 332A, 332B, and 332C may comprise any element configured to be visually detectable by an individual mounting a tire on a wheel 320. In one embodiment, rim centering tolerance indicator 332A, 332B, and 332C comprises a raised indicia extending from the surface of the tire. In another embodiment, rim centering tolerance indicator 332A, 332B, and 332C comprises a recessed indicia extending into the surface of the tire. In another embodiment, rim centering tolerance indicator 332A, 332B, and 332C comprises a combination of raised and recessed indicia. In one embodiment, rim centering tolerance indicator 332A, 332B, and 332C comprises a colored indicia placed upon, formed into, or both, the tire. In one embodiment, the tire comprises a plurality of rim centering tolerance indicators 332A, 332B, and 332C each of which may comprise differing or alternating colors, textures, raised portions, recessed portions, and the like. Rim centering indicator 332A, 332B, and 332C may extend substantially circumferentially about the tire.

When the tire is mounted on wheel 320, at least one of rim centering tolerance indicators 332A, 332B, and 332C may be aligned with or visible around rim flange 322. In one embodiment, rim flange 322 extends across the bead area of the tire from a radially-inwardly direction (the flange comprising an outer radius) and terminates at or near at least one of rim centering tolerance indicators 332A, 332B, and 332C. In one embodiment, concentrically orienting an outer radius of rim flange 322 with at least one of rim centering tolerance indicators 332A, 332B, and 332C may indicate to an individual mounting the tire onto wheel 320 that the tire is substantially concentric with, or within rim centering tolerance with, wheel 320.

In one embodiment, any of various wheels 320 upon which the tire may be mounted comprise any of various geometries and sizes of rim flanges 322. Rim flange 322 on one wheel 320 may extend a radially greater or lesser distance than a comparable rim flange 322. As such, the tire may comprise a plurality of rim centering tolerance indicators 332A, 332B, and 332C to take into account various rim flange geometries and sizes. Concentric alignment of at least one rim centering tolerance indicator 332A, 332B, and 332C with an outer radius of rim flange 322 may indicate to an individual mounting the tire onto wheel 320 that the tire is substantially concentric with wheel 320. In one embodiment, rim flange 322 may comprise an outer radius greater than a radius of at least one rim centering tolerance indicator 332A, 332B, and 332C, and as such may conceal that particular rim centering tolerance indicator 332A, 332B, and 332C from view. However, rim flange 322 may comprise an outer radius less than a radius of another rim centering tolerance indicator 332A, 332B, and 332C, which can be used to visually confirm concentricity of the tire and wheel 322. In one embodiment, the radius of a first rim centering tolerance indicator 332A and the radius of a second rim centering tolerance indicator 332B differ by a distance D1 of about 1.5 mm. The radius of a first rim centering tolerance indicator 332A and the radius of a second rim centering tolerance indicator 332B may differ by distance D1 of about 1.6 mm. In one embodiment, the radius of a third rim centering tolerance indicator 332C and the radius of a second rim centering tolerance indicator 332B differ by a distance D2 of about 1.5 mm. The radius of a third rim centering tolerance indicator 332C and the radius of a second rim centering tolerance indicator 332B may differ by distance D2 of about 1.6 mm. In one embodiment, the radius of a first rim centering tolerance indicator 332A and the radius of a third rim centering tolerance indicator 332C differ by about 3.2 mm equal to distance D1 plus distance D2. The radius of a first rim centering tolerance indicator 332A and the radius of a third rim centering tolerance indicator 332C may differ by about 3.0 mm equal to distance D1 plus distance D2.

In one embodiment, the radius of a first rim centering tolerance indicator 332A and the radius of a second rim centering tolerance indicator 332B differ by a distance D1 of any distance less than the section height of a tire. In one embodiment, the radius of a third rim centering tolerance indicator 332C and the radius of a second rim centering tolerance indicator 332B differ by a distance D2 of any distance less than the section height of a tire.

Viewfinder 308 may include a height H. Height H may be the radial height of viewfinder 308 when apparatus 300 is mounted on wheel 320. Height H may be a height measured substantially parallel to the longitudinal length of neck portion 306. Height H may be about 3.2 mm. Height H may be about 3.0 mm. Height H may be less than about 3.2 mm. Height H may be greater than about 3.0 mm. Height H may correspond to the radial distance between reference marks included on a lens oriented in viewfinder 308, rather than the radial height of viewfinder 308.

In one embodiment, the industry standard tolerance for tire and rim alignment, herein referred to as a rim centering tolerance, may be about 1.5 mm. In another embodiment, the industry standard tolerance for tire and rim alignment, herein referred to as a rim centering tolerance, may be about 1.6 mm.

In one embodiment, viewfinder 308 is initially centered upon the central rim centering tolerance indicator 332B. Central rim centering tolerance indicator 332B may be the targeted reference point on sidewall 330.

FIG. 3B illustrates an example embodiment of apparatus 300 operatively connected to wheel 320 and aligned relative to rim centering tolerance indicators 332A, 332B, and 332C.

As illustrated, central rim centering tolerance indicator 332B may no longer be centered within viewfinder 308. Height H of viewfinder 308 may be about 3.0 mm to about 3.2 mm, which may represent twice the allowable tolerance in concentricity of a tire upon a wheel 320. In this manner, where central rim centering tolerance indicator 332B is originally centered (radially) within viewfinder 308 at a first point, the tire may be within allowable tolerances of concentricity as long as central rim centering tolerance indicator 332B is anywhere within viewfinder 308 when a user applies apparatus 300 to a second point of a tire. It is contemplated that a user may check at least two points of a tire, which points are evenly distributed about the circumference of the tire.

Where central rim centering tolerance indicator 332B no longer falls within viewfinder 308 at some point about the circumference of the tire, a user may know that the tire is outside the allowable tolerances of concentricity, thus requiring dismounting of the tire from wheel 320 and remounting of the tire upon wheel 320 in a more concentric manner.

In practice, a user may test concentricity after the tire has been mounted on wheel 320 but before the tire and wheel assembly is balanced. In one embodiment, a user may test concentricity after the tire has been mounted on wheel 320 and after the tire and wheel assembly is balanced.

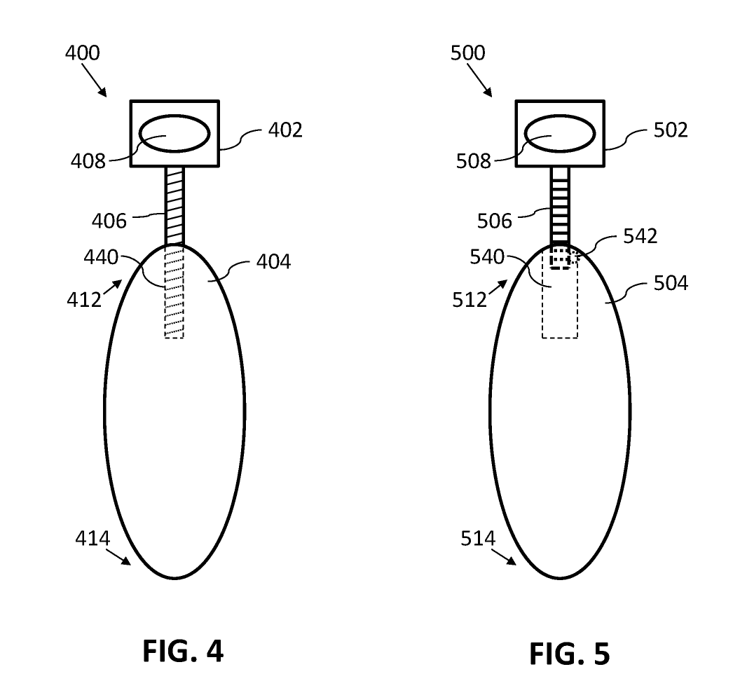

FIG. 4 illustrates a rear elevation view of an example embodiment of an apparatus 400 for determining concentric mounting of a tire on a wheel. Apparatus 400 may include a head portion 402, a body portion 404, and a neck portion 406 connecting head portion 402 to body portion 404. Head portion 402 may include a viewfinder 408. Apparatus 400 may include at least one index member (not shown). Body portion 404 may include a distal end 412 and a proximal end 414.

Neck portion 406 may include a threaded shaft. Body portion 404 may include a threaded cavity 440 extending from distal end 412, corresponding to a threaded shaft of neck portion 406, and configured to accept at least a portion of neck portion 406. Rotation of at least one of head portion 402 and neck portion 406 may cause at least a portion of neck portion 406 to extend into threaded cavity 440. A user may rotate at least one of head portion 402 and neck portion 406 to translate head portion 402 longitudinally relative to body portion 404 to cause the distance between head portion 402 and body portion 404 to increase or decrease.

FIG. 5 illustrates a rear elevation view of an example embodiment of an apparatus 500 for determining concentric mounting of a tire on a wheel. Apparatus 500 may include a head portion 502, a body portion 504, and a neck portion 506 connecting head portion 502 to body portion 504. Head portion 502 may include a viewfinder 508. Apparatus 500 may include at least one index member (not shown). Body portion 504 may include a distal end 512 and a proximal end 514.

Neck portion 506 may include a shaft having transverse grooves. Body 504 may include a cavity 540 extending from distal end 512, and configured to accept at least a portion of neck portion 506. Cavity 540 may include a detent element 542 configured to selectively engage at least one transverse groove of neck portion 506. In practice, detent element 542 may be arranged such that a user may translate head portion 502 longitudinally relative to body portion 504 to cause the distance between head portion 502 and body portion 504 to increase or decrease. Detent element 542 may be any element selectively or continuously biased into engagement with neck portion 506, thus at least partially restraining neck portion 506 relative to body 504.

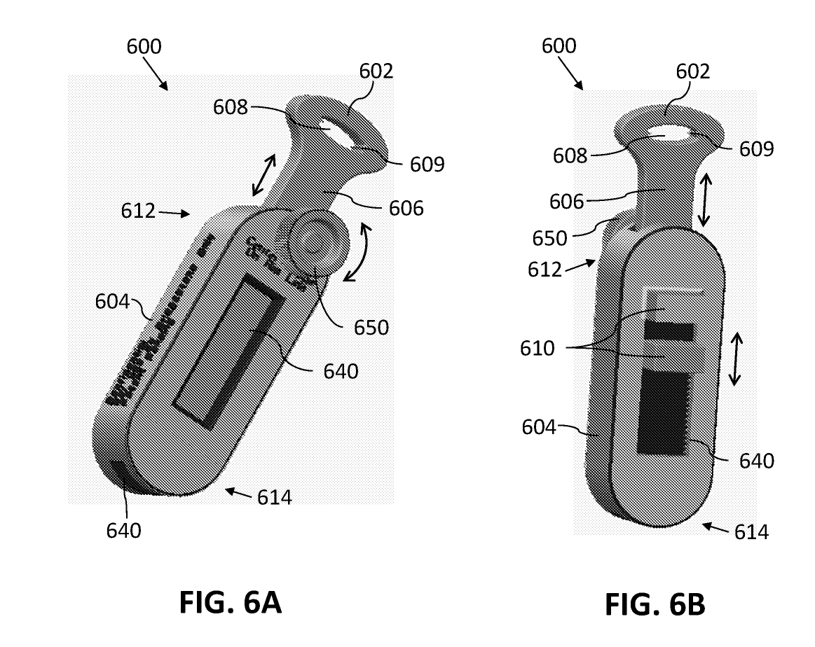

FIGS. 6A and 6B illustrate an apparatus 600 for determining concentric mounting of a tire on a wheel. Apparatus 600 may include a head portion 602, a body portion 604, and a neck portion 606 connecting head portion 602 to body portion 604. Apparatus 600 may include at least one index member 610. Body portion 604 may include a distal end 612 and a proximal end 614. Head portion 602 and neck portion 606 may be connected, and may move longitudinally relative to body portion 604, as indicated by the arrow in FIGS. 6A and 6B.

Head portion 602 may include a viewfinder 608. Viewfinder 608 may include an aperture. Viewfinder 608 may include targeting protrusions 609 oriented at a central point of viewfinder 608 that is equal to half of the height of viewfinder 608. Targeting protrusions 609 may be used to more accurately align viewfinder 608 with a feature on a tire, such as a rim centering tolerance indicator (not shown).

Body portion 604 may include a cavity 640 extending from distal end 612, corresponding to neck portion 606, and configured to accept at least a portion of neck portion 606. Neck portion may include any of a variety of cross-sections, including a square cross-section, a rectangular cross-section, or the like. Cavity 640 may have a cross-section that corresponds to the cross-section of neck portion 606. At least a portion of neck portion 606 may extend into cavity 640. At least a portion of neck portion 606 may slide longitudinally within cavity 640.

Apparatus 600 may include a locking element 650 configured to selectively arrest motion of neck portion 606. Locking element 650 may be oriented on body portion 604. Locking element 650 may interact with a portion of body portion 604. Locking element 650 may interact with a portion of cavity 640. Locking element 650 may interact with a portion of neck portion 606. Locking element 650 may provide a force between body portion 604 and neck portion 606. Locking element 650 may include a rotatable element configured to selectively provide a force onto neck portion 606 relative to body portion 604 to selectively arrest motion of neck portion 606. Locking element 650 may include a threaded element which may translate toward neck portion 606 within cavity 640 upon rotation of locking element 650. Locking element 650 may include a cam element which may engage a portion of neck portion 606 within cavity 640 upon rotation of locking element 650. In any embodiment, rotation of locking element 650 in one direction may arrest the motion of neck portion 606, while rotation of locking element 650 in another direction may free the motion of neck portion 606.

Locking element 650 may include any of a variety of other elements, including a pin or a clamp configured to be engaged so as to provide a force between body portion 604 and neck portion 606, including the portion of neck portion 606 oriented within cavity 640.

As illustrated in FIG. 6B, at least one index member 610 may include two index members 610. A first index member 610 may be fixedly connected to body portion 604. The fixed index member 610 may be oriented closer to distal end 612. The fixed index member 610 may be oriented closer to proximal end 614.

A second index member 610 may be movably connected to body portion 604. The movable index member 610 may be oriented closer to proximal end 614. The movable index member may be oriented closer to distal end 612. The movable index member 610 may translate along the longitudinal axis of body portion 604. The movable index member 610 may translate along an axis parallel to an axis along which neck portion 606 may translate.

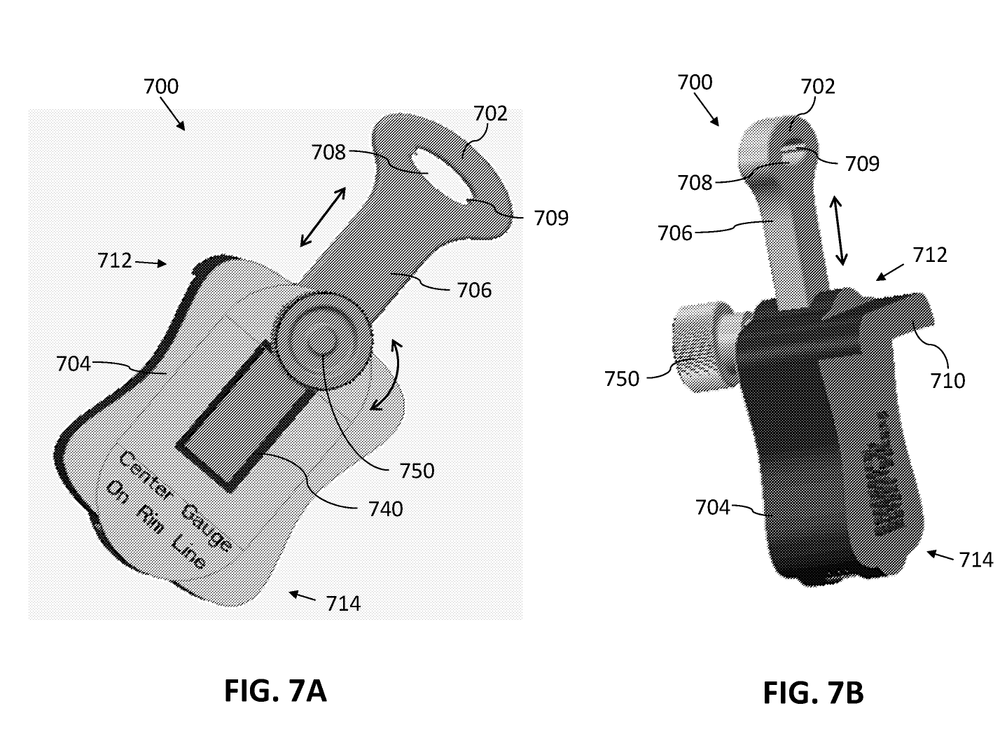

FIGS. 7A and 7B illustrate an apparatus 700 for determining concentric mounting of a tire on a wheel. Apparatus 700 may include a head portion 702, a body portion 704, and a neck portion 706 connecting head portion 702 to body portion 704. Apparatus 700 may include at least one index member 710. Body portion 704 may include a distal end 712 and a proximal end 714. Head portion 702 and neck portion 706 may be connected, and may move longitudinally relative to body portion 704, as indicated by the arrow in FIGS. 7A and 7B.

Head portion 702 may include a viewfinder 708. Viewfinder 708 may include an aperture. Viewfinder 708 may include targeting protrusions 709 oriented at a central point of viewfinder 708 that is equal to half of the height of viewfinder 708.

Apparatus 700 may include a locking element 750 configured to selectively arrest motion of neck portion 706.

As illustrated in FIG. 7B, at least one index member 710 may include one index members 710. Index member 710 may be fixedly connected to body portion 704. The fixed index member 710 may be oriented closer to distal end 712. The fixed index member 710 may be oriented closer to proximal end 714.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. An apparatus for determining concentric mounting of a tire on a wheel, comprising:
a head portion including a viewfinder;
a body portion including at least one index member; and
a neck portion connecting the head portion to the body portion.

2. The apparatus of claim 1, wherein the neck portion has a longitudinal length, and wherein the longitudinal length of the neck portion is adjustable so as to cause a distance between the head portion and the body portion to selectively increase or decrease.

3. The apparatus of claim 1, wherein the at least one index member includes two index members, and wherein at least one of the two index members moves relative to the other of the two index members so as to cause a distance between the two index members to selectively increase or decrease.

4. The apparatus of claim 1, wherein the neck portion extends at least partially into a cavity within the body portion.

5. The apparatus of claim 1, wherein the viewfinder includes a height of about 3.2 mm.

6. The apparatus of claim 1, wherein the viewfinder includes an aperture extending completely through the head portion.

7. The apparatus of claim 1, wherein the viewfinder at least one targeting protrusion.

8. A system for determining concentric mounting of a tire on a wheel, comprising:
an apparatus for determining concentric mounting of a tire on a wheel, including:
a head portion including a viewfinder;
a body portion including at least one index member; and
a neck portion connecting the head portion to the body portion
a wheel comprising a rim flange; and
a tire mounted on the wheel, the tire including a sidewall comprising at least one rim centering tolerance indicator.

9. The system of claim 8, wherein the apparatus for determining concentric mounting of the tire on the wheel is operatively connected to the wheel via an engagement of the at least one index member with the rim flange.

10. The system of claim 8, wherein the at least one index member includes two index members, and wherein at least one of the two index members moves relative to the other of the two index members so as to cause a distance between the two index members to selectively increase or decrease, wherein one of the two index members is oriented on a radially first side of the rim flange, and wherein the other of the two index members is oriented on a radially second side of the rim flange.

11. The system of claim 8, wherein the neck portion has a longitudinal length, and wherein the longitudinal length of the neck portion is adjustable so as to cause a distance between the head portion and the body portion to selectively increase or decrease.

12. The system of claim 11, wherein the viewfinder is aligned with the at least one rim centering tolerance indicator.

13. The system of claim 11, wherein the at least one rim centering tolerance indicator comprises three radially spaced rim centering tolerance indicators, and wherein the viewfinder is aligned with a radially central rim centering tolerance indicator.

14. The system of claim 8, wherein the at least one rim centering tolerance indicator comprises three radially spaced rim centering tolerance indicators, and wherein the viewfinder has a height equal to the radial distance between a radially innermost rim centering tolerance indicator and a radially outermost rim centering tolerance indicator.

15. The system of claim 8, wherein the neck includes a threaded shaft and wherein the body includes a threaded cavity.

16. The system of claim 8, wherein the neck portion extends at least partially into a cavity within the body portion.

17. The system of claim 8, wherein the viewfinder includes an aperture extending completely through the head portion.

18. The system of claim 17, wherein at least a portion of the sidewall is visible through the viewfinder.

19. The system of claim 8, wherein the viewfinder includes a lens including at least one reference mark or at least one reference line.

20. The system of claim 8, wherein the viewfinder includes at least one targeting protrusion.
